(19) United States
(12) Patent Application Publication
(10) Pub. No.: US 2008/0313948 A1
(43) Pub. Date: Dec. 25, 2008

(54) Fishing lure

(76) Inventor: Paul Lewis, Orono, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/821,316

(22) Filed: Jun. 22, 2007

(51) Int. Cl. A01K 85/02

(52) U.S. Cl. 43/42.24; 43/42.28; 43/42.39; 43/42.35

(57) ABSTRACT

An improved lure for use when fishing provides better control of the lure by novice and experienced fishermen, better camouflage of the hook and weighting system associated with the lure and more secure setting of the hook when a fish bites. The improved lure comprises a standard tube bait in combination with a hook and weighting arrangement that makes the lure easier to use than prior art tube baits.

### BACKGROUND OF THE INVENTION

I. Field of the Invention

The present invention relates to soft plastic tube-type fishing lure. More specifically, the present invention relates to improvements to tube-type fishing lures concerning their ability to attract fish and their ability to securely hook a fish that bites the bait.

II. Description of the Prior Art

Tube baits generally consist of a soft plastic tube surrounding a cavity and having a generally closed end and an open end. A plurality of plastic tentacles extends from the open end of the tube. Tube baits also include a hook. The hook has an eye, point, barb, shank and bend creating a gap between the shank and the barb typically, a single hook with a wide gap is used with tube baits. The shaft sometimes exits the open end of the tube such that the curve positions the barb parallel to the center axis of the body of the tube. Alternatively, the user can push the point of the hook through the soft body of the tube and positions the barb of the hook outside of the tube and generally parallel to the center axis of the body of the tube. In either case, the eye (and sometimes a portion of the shank) is pushed through the closed end of the tube. Sometimes a weight is also attached to the shank of the hook outside the tube between the eye of the hook and the front closed end of the tube. However, such a weight can result in an unnatural appearance.

Prior art tube baits have proven to be effective when used by experienced professional anglers. However, amateurs and inexperienced anglers have difficulty catching fish with such baits. Some of the problems inexperienced anglers encounter relate to their inability to get the tube bait to mimic the patterns real minnows and crawfish display. Minnows, for example, tend to drift down through the water without their heads pointing either up or down. If the weight distribution of a tube bait is such that either end of the tube points down as it falls through the water, the tube bait will look unnatural to fish in the area. Likewise, if the angler does not provide enough slack in the line, the closed end will point up as the tube bait drifts down presenting an unnatural appearance.

Inexperienced anglers also have problems setting the hook of prior art tube baits. If the hook is not set so it penetrates both soft tissue and one of the bones of the mouth of the fish, large fish or those that put up a fight easily can escape.

### SUMMARY OF THE INVENTION

The present invention addresses each of the problems with prior art tube baits outlined above. To provide a more natural presentation of the tube bait to fish in the area, a unique and distributed weighting mechanism is provided. To reduce problems associated with setting the hook, the hook having a single point used in the prior art is replaced by a hook having a plurality of points and barbs is used.

The construction of the improved tube bait of the present invention will be better understood from the following detailed description of the preferred embodiment with specific reference to the accompanying drawings.

### BRIEF DESCRIPTION OF THE DRAWINGS

FIG. 1 is a perspective view of a prior art tube bait.

FIG. 2 is a cross-sectional view of the tube bait of FIG. 1 through line 2-2.

FIG. 3 is a perspective view of the tube bait of the present invention.

FIG. 4 is a cross-sectional view of the tube bait through line 3-3 of FIG. 2 showing a first embodiment of the tube bait of the present invention.

FIG. 5 is a cross-sectional view of the tube bait through line 3-3 of FIG. 3 showing a second embodiment of the present invention.

FIG. 6 is a cross-sectional view of the tube bait through line 303 of FIG. 2 showing a third embodiment of the present invention.

### DETAILED DESCRIPTION OF THE PREFERRED EMBODIMENT

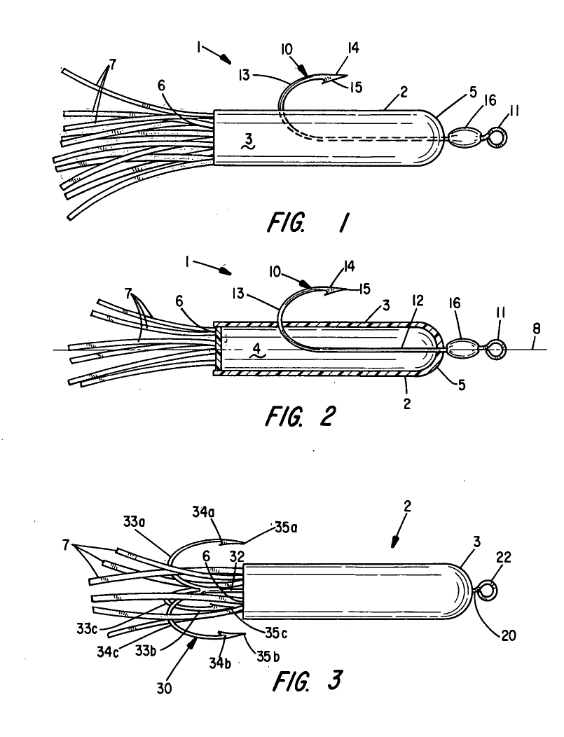

As shown in FIGS. 1 and 2, prior art tube baits 1 typically comprise a tube 2 having a soft plastic wall 3 surrounding a hollow chamber 4. The wall 3 has a front closed end 5 and an open rear end 6. Projecting rearwardly from the tube 2 and attached to the rear end 6 of the tube 2 is a number of soft, flexible plastic tentacles 7. The tube is generally hollow and has a central axis 8. The tube bait 1 also has a hook 10. The hook 10 is generally J-shaped and includes an eye 11 for attaching the hook 10 to a fishing line, a shank 12 extending from the eye 11 to a curve 13 and a barb 14 extending from the curve 13 to a point 15. The major portion of the shank 12 is positioned inside the hollow chamber 4. The shank 12 penetrates the front closed end 5 of the tube 2 to expose the eye 11. The curve 13 penetrates wall 3 of tube 2 intermediate the front end 5 and rear end 6 of the tube 2. Thus, the barb 14 and point 15 of the hook reside outside of the tube 2. The barb 14 is generally parallel to the central axis 8 of the tube 2. FIG. 1 also shows an exterior weight 16 attached to the shank 12 of the hook 10 between the eye 11 of the hook and the front end 5 of the tube 2. The eye 11 is used to attach the tube bait to a fishing line (not shown) in a conventional manner.

The positioning of the weight 16 in FIG. 1 typically causes the tube bait 1 to tip with the weight down as the tube bait descends through the water resulting in an unnatural presentation. Also, the single barb 14 and point 15 of the hook 10 makes the typical tube bait difficult to set when a fish bites or nibbles on the tube bait. The wide gap and exposed barb 14 and point 15 of the hook also result in an unnatural appearance. These problems are all overcome by the embodiments of the present invention disclosed in FIGS. 3-6.

The embodiments of FIGS. 3-6 still all comprise a soft plastic tube 2 having a wall 3 terminating in a front end 5 and a rear end 6. The front end 5 is typically closed while the rear end 5 is open to the hollow chamber 4 of the tube 2. Attached to and extending away from the rear end 6 of the tube 2 is a plurality of tentacles 7. However, each of the four embodiments shown in FIGS. 3-6 show important improvements over prior art tube baits.

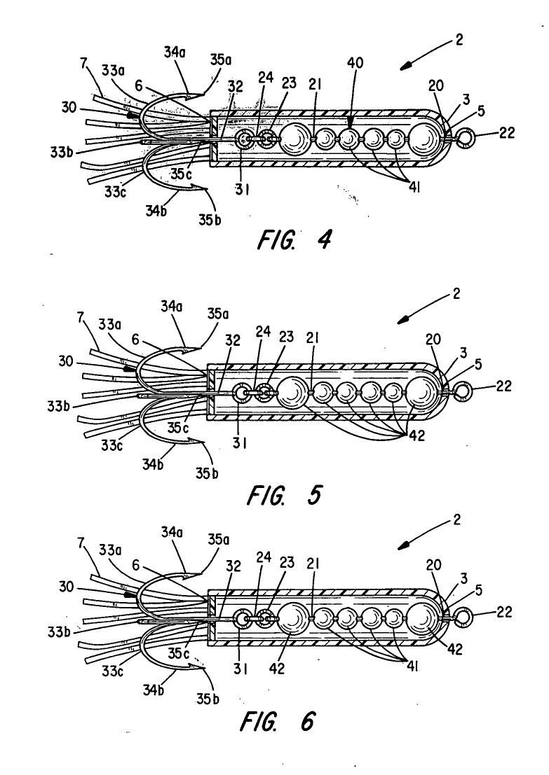

FIGS. 3-6 each show a leader 20 and a treble hook 30. FIGS. 4-7 also each show an interior weighting mechanism 40. However, as described below the interior weighting mechanism 40 shown in each of FIGS. 4-6 is different.

The leader 20 shown in each of FIGS. 3-6 comprises a shaft 21 made of a length of wire with eyelets 22 and 23 formed at each end of the leader 20. When used, the eyelet 22 is used to attach the tube bait to a fishing line (not shown) in any conventional manner. The eyelet 23 is used to attach the treble hook 30 to the leader 20. In the drawings, such attachment is made using a coupling ring 24. However, other conventional means can also be used to attach the hook 30 to the leader 20 without deviating from the invention. The length of the shaft 21 may be adjusted depending on the composition of the interior weighting mechanism used.

As shown, treble hook 30 comprises an eye 31, a shank 32, three J-shaped curves (33a, 33b and 33c) and three barbs (34a, 34b and 34c) each terminating in a point (35a, 35b and 35c). The shank 32 can, of course, be three separate shanks fused or otherwise joined together. Eye 31 is used to join the hook 30 to the leader 20. While a treble hook 30 is shown in the drawings, what is important is that the hook presents a plurality of barbs and points as opposed to a single barb and point. Thus, any hook with two or more barbs and points may suffice. The advantage of using a hook with multiple barbs such as treble hook 30 is that the hook will more securely set in either the soft tissue or bone of the fish at multiple points as opposed to a single point.

The various interior weighting mechanisms 40 shown in FIGS. 3-6 provide various advantages related to the speed of the tube bait 1 as it drops through the water and the presentation of the tube bait 1 as it descends through the water. As shown in FIGS. 3-6, the interior weighting mechanism 40 resides within the hollow interior chamber 4 of tube 2 and about the shaft 21 of the leader 20. In FIG. 3, the interior weighting mechanism 40 includes a plurality of spherical weights 41 of differing sizes and/or densities. Each spherical weight 41 has a bore sized to permit the shaft 21 to pass through the weight 41. The distribution of weights of different sizes or densities along the shaft 21 allows for control of the presentation of the tube bait during descent. Specifically, the distribution of the weights of different diameters or densities along shaft 21 can be used to ensure that the tube bait drifts down without either end tipping markedly downward or upward relative to the other. Of course, the correct distribution of smaller and larger weights 41 along the shaft 21 will be dependent on the characteristics of the plastic tube 2 and tentacles 7. Also, if the weights 41 are not packed too tight on the shaft 21, some rattling of the weights will occur which also serves to attract fish. The weighting mechanism 40 could also include a time release capsule filled with a scent that either attracts fish or masks the human scent of the angler which may have transferred to the tube bait 1.

The plastic used to form the tube 2 and tentacles 7 may be sufficiently dense to cause the tube bait to sink on its own without adding weights 41. Even when this is the case, it may be desirable to control the rate of descent or to prevent the ends of the tube 2 from pointing up or down as the tube bait 1 descends. Such control is provided in the embodiment of FIG. 5 by replacing the spherical weights 41 with one or more low density internal floats 51. Such floats may be of different sizes and densities like the weights 41. Each will typically have a bore therethrough so the floats 51 can be arranged on the shaft 21 of the leader 20 and within the hollow chamber 4 of tube 2. Proper arrangement of floats 42 on the shaft 21 will again depend on the composition of the tube 2 and tentacles 7. They should be arranged to provide generally level descent at the proper rate. In FIG. 6, a combination of floats 42 and weights 41 are arranged on the shaft 21 and within the hollow chamber 4 to provide such level descent at the proper rate.

The various embodiments shown in FIGS. 3-6 provide important advantages over the prior art. First, the overall appearance is more realistic. There is no large weight at the front as in FIG. 1. Instead, the weights 41 (and/or floats 42) are all located within the hollow chamber 4 of the tube 2. Further, there is no large hook projecting through the side of the tube 2 as shown in FIG. 1. Instead, the barbs 34a, 34b and 34c of the treble hook 30 are all to a very large extent camouflaged by the tentacles 7.

Second, the presentation of the tube bait as it drifts down through the water is more lifelike since the interior weighting mechanism 40 (i.e., the weights 41 and floats 42) provide not only a proper rate of descent, but also substantially eliminate tipping of the tube as it slowly drops through the water. Locating the weights and floats inside the hollow chamber of the tube bait also results in a more natural appearance.

Third, the hook 30 of the present invention provides multiple potential points of contact between the mouth of the fish and the hook. Catching soft tissue with more than one point and barb is typically enough to prevent the fish from escaping the hook even if bone is not penetrated by any of the barbs and points.

Those skilled in the art will recognize from the foregoing disclosure that the present invention provides important advantages over the prior art. Those skilled in the art will also appreciate that modifications can also be made without deviating from the present invention. Thus, the foregoing description is intended to meet the disclosure requirements of the patent laws without being limiting.

What is claimed is:

1. A fishing lure comprising:
a. a soft plastic tube having a front substantially closed end and a rear end substantially open to a hollow chamber of the soft plastic tube;
b. a plurality of tentacles attached to and extending from the rear end of said tube;
c. a leader having a shaft, a first eyelet at one end of the shaft, and a second eyelet at the other end of the shaft, a major portion of said shaft residing in the hollow chamber of said tube, a portion of said shaft extending through said front substantially closed end of said tube so that said first eyelet of said leader resides outside of the tube in close proximity to the front substantially closed end of said tube;
d. a hook coupled to said second eyelet of said leader, said hook having a plurality of barbs and points; and
e. an interior weighting mechanism positioned about the shaft of said leader and inside the hollow chamber of the soft plastic tube.

2. The fishing lure of claim 1 wherein said interior weighting mechanism includes a plurality of weights.

3. The fishing lure of claim 2 wherein at least one of said weights differs from another of said weights in size.

4. The fishing lure of claim 2 wherein at least one of said weights differs from another of said weights in density.

5. The fishing lure of claim 1 wherein said interior weighting mechanism includes a plurality of floats.

6. The fishing lure of claim 5 wherein at lest one of said plurality of floats differs from another of said plurality of floats in size.

7. The fishing lure of claim 5 wherein at least one of said plurality of floats differs from another of said floats in density.

8. The fishing lure of claim 1 wherein said interior weighting mechanism includes at least one weight and at least one float.

9. The fishing lure of claim 1 wherein said interior weighting mechanism includes a first member and a second member, said first member capable of sliding along the shaft and contacting said second member to create a sound.

10. The fishing lure of claim 1 wherein said weighting mechanism includes a scent to attract fish.

11. The fishing lure of claim 1 wherein said weighting mechanism includes a scent to mask human scent.
